(19) United States
(12) Patent Application Publication
(10) Pub. No.: US 2019/0043372 A1
(43) Pub. Date: Feb. 7, 2019

(54) SYSTEMS, DEVICES, AND METHODS FOR GENERATING ROUTES WITHIN LIMITED COMMUNICATION ZONES

(71) Applicant: Walmart Apollo, LLC, Bentonville, AR (US)

(72) Inventors: David Winkle, Bella Vista, AR (US); John Jeremiah O'Brien, Farmington, AR (US)

(21) Appl. No.: 16/053,993

(22) Filed: Aug. 3, 2018

Related U.S. Application Data
(60) Provisional application No. 62/541,156, filed on Aug. 4, 2017.

(51) Int. Cl. G08G 5/00; B64C 39/02; H04B 17/318

(52) U.S. Cl. CPC G08G 5/0069; G08G 5/0008; G08G 5/0039; B64C 2201/141; H04B 17/318; B64C 2201/122; B64C 2201/126; B64C 39/024

(57) ABSTRACT

Methodologies, systems, and computer-readable media are provided for generating routes for aerial drones. A computing system generates a first navigation route to guide a first aerial drone from an origin location to a destination location which includes passing through a limited coverage zone. The aerial drone is configured to periodically transmit information to a remote computing device. The computing system also generates the second navigation route to guide a second aerial drone near the limited coverage zone and within communication range of the first aerial drone when the first aerial drone is passing through the limited coverage zone. Relay instructions are also generated by the computing system to prompt the first aerial drone to relay the information via the second aerial drone to the remote computing device while the first aerial drone is in the limited coverage zone.

### CROSS-REFERENCE TO RELATED PATENT APPLICATIONS

This application claims priority to U.S. Provisional Application No. 62/541,156 filed on, Aug. 4, 2017, the content which is hereby incorporated by reference in its entirety.

### BACKGROUND

Various types of robots and delivery vehicles can be programmed to travel autonomously. Autonomous vehicles may be ground-based or aerial vehicles. The autonomous vehicles may be configured for wireless communication during transit.

### BRIEF DESCRIPTION OF THE DRAWINGS

The skilled artisan will understand that the drawings are primarily for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

The foregoing and other features and advantages provided by the present invention will be more fully understood from the following description of exemplary embodiments when read together with the accompanying drawings, in which:

FIG. 1 is a flowchart illustrating an exemplary method for generating navigation routes within limited communication coverage zones, according to an exemplary embodiment.

FIG. 2 is a flowchart illustrating another exemplary method for generating a dynamic 3D communication map, according to an exemplary embodiment.

FIG. 3 is a flowchart illustrating an exemplary method for generating navigation routes and communication recommendations, according to an exemplary embodiment.

FIG. 4 is a flowchart illustrating an exemplary method for processing data used in dynamically generating a 3D communication map, according to an exemplary embodiment.

FIG. 5 is a chart of example navigation routes for relaying messages in limited communication coverage zones, according to an exemplary embodiment.

FIG. 6 is a diagram of an exemplary network environment suitable for a distributed implementation of an exemplary embodiment.

FIG. 7 is a block diagram of an exemplary computing device that can be used to perform exemplary processes in accordance with an exemplary embodiment.

### DETAILED DESCRIPTION

Following below are more detailed descriptions of various concepts related to, and embodiments of, inventive methods, apparatus, and systems for associating delivery information with a remotely located package. It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes.

As used herein, the term “includes” means “includes but is not limited to”, the term “including” means “including but not limited to”. The term “based on” means “based at least in part on”.

According to conventional techniques, robotic vehicles or aerial drones can communicate with land based communication stations. However, in order to be able to continuously receive and transmit information, the aerial drones are limited to traveling within the coverage zones of the communication stations or signal sources. Exemplary embodiments of the present disclosure facilitate generating navigation routes for aerial drones in order to relay information between drones while within limited communication coverage zones. In some embodiments, the navigation routes are based on a dynamic 3D communication map that can respond to real-time changes in signal strength and signal usability.

In exemplary embodiments, a first aerial drone is configured to travel from an origin location to a destination location along a first navigation route and periodically transmit information to a remote computing device. Along the first navigation route, the first aerial drone is configured to pass through a limited communication coverage zone. In some embodiments, a limited coverage zone includes an area where the aerial drone can receive communications but is not able to transmit communications, or where the ability to send and receive communications is unreliable. The remote computing device is configured to generate the first navigation route and receives wireless communication signal data from a 3D communication map in order to identify limited communication coverage zones. The remote computing device is also configured to generate a second navigation route to guide a second aerial drone near the limited coverage zone and within communication range of the first aerial drone when the first aerial drone is passing through the limited coverage zone. Relay instructions are also generated by the remote computing device in order to prompt the first aerial drone to relay the information to the remote computing device via the second aerial drone.

In some embodiments, the second aerial drone can act as a repeater or relaying device in order to provide increased range of travel for the first aerial drone. One or more of the aerial drones can also include reconfigurable antennas that can adjust their configuration in order to provide increased range while within limited coverage zones, in some embodiments. In alternative embodiments, the second aerial drone can travel to a particular location near the first aerial drone in order to temporarily relay communications between the first aerial drone and a remote computing system. For example, if the first aerial drone needs to travel to a limited coverage zone in order to complete a sales transaction, the second aerial drone can travel near to the limited coverage zone and within the communication range of the first aerial drone for a short amount of time in order to allow the first aerial drone to complete the transaction. Once the transaction is complete, the second aerial drone can resume a previous navigation route or return to its origin location.

In exemplary embodiments, a dynamic 3D communication map can be generated by collecting data from a number of aerial drones as they navigate through a particular area. The aerial drones can collect environmental data, location data, signal strength data, signal usability data, etc. and transmit that data back to a computing system. In some embodiments, that data can be received at the computing system and analyzed in real-time and used to generate a dynamic 3D communication map that can indicate the signal strength and the signal usability of various wireless communication signal types as a function of time, season, weather patterns, etc. In some embodiments, vector analysis can be used to identify obstacles that may obstruct wireless signals and generate acceptable regions or pathways within the dynamic 3D communication map where ideal signal strength and/or usability can be found. For example, the 3D communication map can be a vector map that takes into account signal attenuation due to ambient conditions, structural features, traffic patterns, population density, etc. In some embodiments, the positioning of an aerial drone, the positioning of obstacles or objects detected by the drone's sensors, and/or the attenuation or signal strength of a signal can be determined based on the proximity to a data communication tower. In some embodiments, the aerial drone can identify a communication tower, identify the tower's known location, and compare the location against the strength of the signal received from the communication tower in order to determine signal strength and/or the location of the drone.

In one example embodiment, partial line-of-sight blocking of a signal can be caused by vehicles temporarily blocking a signal path to an aerial drone, which can result in attenuation of the signal. In response to such an attenuation, the aerial drone can fly at a higher altitude and transmit information to the computing system that a particular type of signal is attenuated at a particular altitude. This attenuation data can be incorporated into the dynamic 3D communication map described herein. In some embodiments, the 3D communication map can serve as a model to predict signal strength and/or signal usability as conditions change, such as temperature, humidity, season, vegetation growth, population density, etc. Various types of vehicles or aerial drones can be deployed to gather information in order to generate the dynamic 3D communication map, such as drones, cars, buses, automated ground vehicles, boats, planes, helicopters, etc. In some embodiments, the dynamic 3D communication map can be configured to identify areas or routes of high or low signal strength or signal usability. These areas or routes can be used to help generate navigation routes and/or communication routes in order to maximize the time that aerial drones can communicate with a central computing system or the time available to generate navigation routes for to relay communications between different aerial drones.

In some embodiments, the altitude of an aerial drone can be determined using an altimeter, such as a laser, or a barometer. The speed or velocity of an aerial drone can be determined using an accelerometer, and the orientation of an aerial drone can be determined using a gyroscope or an accelerometer. In some embodiments, the positioning of an aerial drone can be determined using a magnetometer, compass, or GPS technology.

In additional exemplary embodiments, the dynamic 3D communication map can include information related to the communication signal configuration. The communication signal configuration can include, in some embodiments, which provider or carrier is transmitting the communication signal, whether the communication signal is a cellular or Wi-Fi signal, or which antenna configuration is needed for a particular communication signal. User densities may vary by provider, causing changes in the strength and/or usability of a signal. In some embodiments, signal strength and/or usability may vary based on whether a particular drone is configured for a particular communication protocol (e.g., 2G, 3G, 4G, CDMA, GSM, LTE, etc.). For example, a drone configured to use a particular wireless carrier's Wi-Fi radio and antenna configurations may have different requirements than a drone manufactured by a different carrier or configured to be compatible with a different carrier's communication signals. In some embodiments, usability by provider or carrier may vary by location as a result of advertising or promotional campaigns. The presence of user-deployed repeaters can also impact the signal strength and usability of a particular wireless communication signal type or of a particular provider or carrier. In some embodiments, this information can be used to generate a navigation route, communication route, or to optimize configurations for a particular signal type to include selection of a provider configuration, antenna type or characteristics, radio sensitivity, channel, transmission power levels, etc. For example, it may be beneficial to configure a drone to use a particular cellular provider configuration within a particular area.

Exemplary embodiments are described below with reference to the drawings. One of ordinary skill in the art will recognize that exemplary embodiments are not limited to the illustrative embodiments, and that components of exemplary systems, devices and methods are not limited to the illustrative embodiments described below.

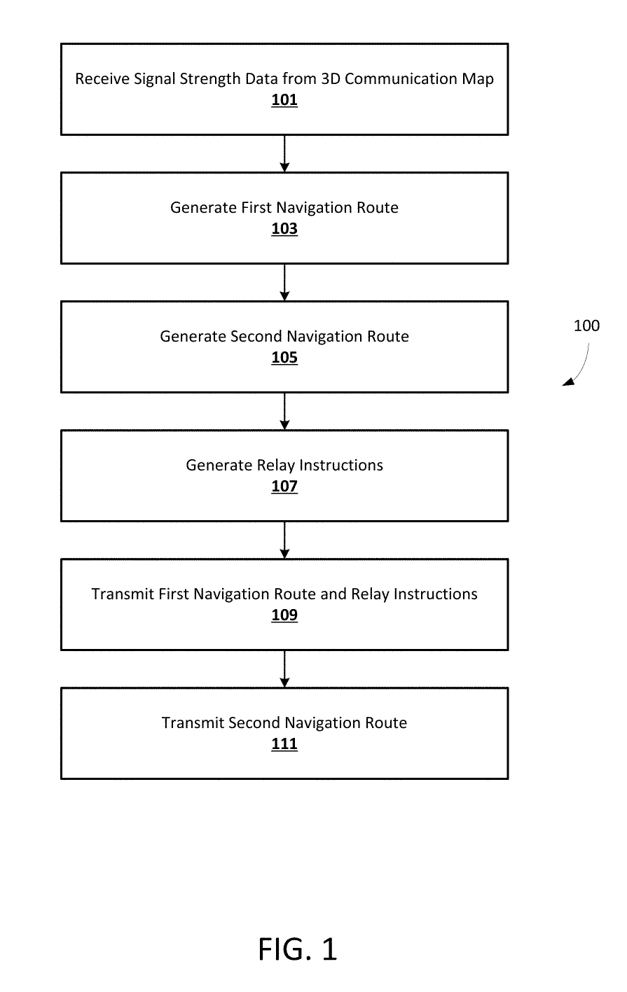

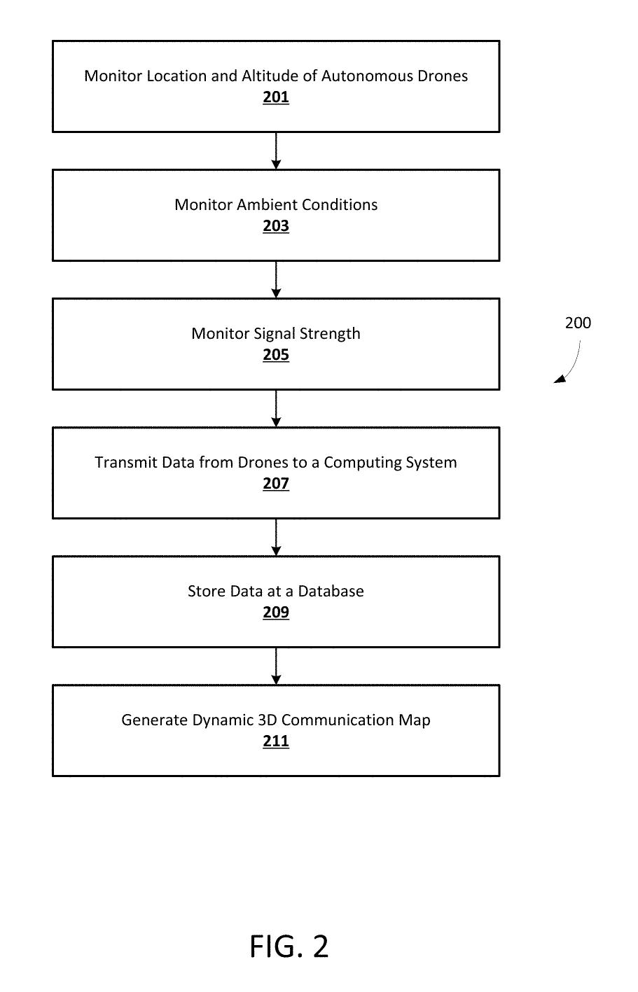

FIG. 1 is a flowchart illustrating an exemplary method 100 for generating and updating navigation routes, according to an exemplary embodiment. It will be appreciated that the method is programmatically performed, at least in part, by one or more computer-executable processes executing on, or in communication with one or more servers or other computing devices as described further below. In step 101, wireless communication signal strength data is received from a dynamic 3D communication map. The dynamic 3D communication map can be generated, for example, as described in more detail below with reference to FIG. 2. The wireless communication signal strength data can be received at a remote computing system and can indicate a limited coverage zone within the area covered by the dynamic 3D communication map. In some embodiments, the limited coverage zone can include an area where wireless communication signal strength is particularly low, or where the usability of wireless communication signals is low. Low signal strength and low signal usability can be caused by a number of factors including, for example, temperature, foliage growth, altitude, population density, weather patterns, etc. In some embodiments, a robotic vehicle, such as an aerial drone or other vehicle, can be configured to travel along a first navigation route between an origin location and a destination location, and the limited coverage zone can be located in an area between the origin location and the destination location.

In step 103, the first navigation route is generated and is configured to guide the first aerial drone from the origin location to the destination location. The first aerial drone is configured to periodically transmit information to the remote computing system and to pass through the limited coverage zone between the origin location and the destination location. In some embodiments, the first navigation route can be generated depending on the type of activities the first aerial drone is configured to perform. For example, if the first aerial drone is a delivery drone, the amount of time the drone can stay within a limited coverage zone or in an area with no wireless communication coverage can be determined based on the level of security of the item being delivered. In some embodiments, a limited coverage zone includes an area where the aerial drone can receive communications but is not able to transmit communications, or where the ability to send and receive communications is unreliable. The limited coverage zones can be determined, in some embodiments, based on specific signal strength and/or signal usability metrics. In some embodiments, the first navigation route is also configured to guide the first aerial drone temporarily through a zone with no connectivity in order to reach the limited coverage zone.

In step 105, a second navigation route is generated and configured to guide a second aerial drone, configured to communicate with the first aerial drone, near the limited coverage zone and within communication range of the first aerial drone at the time when the first aerial drone is passing through the limited coverage zone. By guiding the second aerial drone within communication range of the first aerial drone, any messages or communications can be relayed from the first aerial drone through the second aerial drone, thus providing increased communication while the first aerial drone is passing through the limited coverage zone. In some embodiments, the second aerial drone is selected from a number of aerial drones based, at least in part, on its location, ambient conditions, a level of security of the information being relayed or communicated, time delivery requirements, or battery life.

In step 107, relay instructions are generated and configured to prompt the first aerial drone to relay information to the remote computing system via the second aerial drone. In some embodiments, the relay instructions are also configured to prompt the second aerial drone to relay the information to the remote computing system using a communication processor that is separate and independent from the primary processor of the second aerial drone. The communication processor can be dedicated solely to receiving and relaying information and messages between aerial drones, in some embodiments, in order to maintain the navigational functions of each drone separate from the communication relay functions. In this particular example embodiment, information is relayed from the first aerial drone to the remote computing system via a single aerial drone. However, in other embodiments two or more aerial drones can be guided within communication range of each other to create a chain and relay communications and information between aerial drones using the techniques described herein.

In step 109, the first navigation route and the relay instructions are transmitted to the first aerial drone. In step 111, the second navigation route is transmitted to the second aerial drone. In some embodiments, the initial navigation route, the relay instructions, and the second navigation route can be transmitted directly to the aerial drone from a computing system, or via a relayed communication path, as discussed this disclosure. Once the second aerial drone has followed the second navigation route and relayed the information from the first aerial drone to the remote computing system, the second aerial drone can resume a previous navigation route, in some embodiments. The relay instructions can also prompt the second aerial drone to record time delay information caused by relaying the information via the second aerial drone and to transmit the time delay information, or data latency, to the remote computing system.

FIG. 2 is a flowchart illustrating an exemplary method 200 for generating a dynamic 3D communication map, according to an exemplary embodiment. It will be appreciated that the method is programmatically performed, at least in part, by one or more computer-executable processes executing on, or in communication with one or more servers or other computing devices such as described further below. In step 201, the location and altitude of a number of aerial drones is monitored using location and altitude sensors associated with each drone. Each of the aerial drones is configured to travel along a predetermined route and generates location and altitude data, using the location and altitude sensors, as it travels along the predetermined route. In some embodiments, the location and altitude sensors associated with the aerial drones can include, for example, altimeters, accelerometers, barometers, GPS sensors, or other suitable geolocation sensors. The location of the aerial drones can also be calculated based on the strength of wireless communication signals received from a cell tower or other signal source, in some embodiments.

In step 203, ambient condition data is generated by monitoring ambient conditions using ambient condition sensors with which the drones are equipped including, but not limited to, one or more of barometers, radar, lidar, sonar, anemometers, light sensors, humidity sensors and temperature sensors. In exemplary embodiments, the ambient conditions can include weather data, data relating to geographical and structural features located along the predetermined routes, temperature data, humidity data, seasonal data, vegetation growth, wind speed, or air pressure. The ambient condition data can also include, for example, optical data depicting fog, clouds, buildings, vegetation, traffic or population density, etc. In some embodiments, a barometer can monitor atmospheric pressure and also calculate the altitude of the aerial drone.

In step 205, communication signal strength data is generated by monitoring the signal strength associated with one or more wireless communication signal types using communication signal sensors associated with each drone. In exemplary embodiments, the wireless communication signal types can include Wi-Fi, cellular, Bluetooth, WiMAX, etc. In some embodiments a carrier-to-interference plus noise ratio (CINR) for WiMAX communications can be calculated and used as an indicator of signal strength. For GPS or Differential GPS (D-GPS) signals, a satellite tower provisioning number (measured in number of active satellite connections) can be used as an indicator of signal strength, in some embodiments. For LTE signals, a signal-to-interference plus noise ratio (SINR) can be used as an indicator of signal strength, in some embodiments. For High Speed Packet Access Plus (HSPA+) and Evolution-Data Optimized (EVDO) communication signals, signal strength can be measured in decibels/milliwatt (dBM), and signal quality can be measured in decibels (dB), in some embodiments. In Table 1 below, a listing of exemplary signal strength and signal quality ranges is provided for HSPA+, EVDO, LTE, GPS/D-GPS, and WiMAX communication signals.

TABLE 1

| | | | | | | | GPS/D-GPS | | |
|---|---|---|---|---|---|---|---|---|---|
| | EVDO/HSPA+ | | EVDO/HSPA+ | | LTE | | Satellite Tower | WiMAX | |
| | Signal Strength | | Signal Quality | | SINR | | Provisioning | CINR | |
| Excellent | 0 to −65 | dBM | 0 to −2 | dB | 0 to −2 | dB | >10 active | >22 | dB |
| | | | | | | | connections | | |
| Good | −65 to −75 | dBM | −2 to −5 | dB | −2 to −5 | dB | 7 to 10 | 16 to 22 | dB |
| Fair | −75 to −85 | dBM | −5 to −10 | dB | −5 to −10 | dB | 5 to 7 | 9 to 16 | dB |
| Poor | <−85 | dBM | <−10 | dB | <−10 | dB | <5 | <9 | dB |

In step 207, the location data, altitude data, ambient condition data, and communication signal strength data is transmitted from the aerial drones to a computing system over a communication channel. In some embodiments, the aerial drones can be in continuous communication with one another and/or with the computing system over the communication channel, while in other embodiments the aerial drones can travel in and out of various communication zones. While within a zone of communication, the aerial drones can transmit the location data, altitude data, ambient condition data, communication signal strength data, etc. to the computing system continuously or at predefined intervals. In some embodiments, when the aerial drones travel into an area of limited or no signal coverage, such as the limited coverage zones described above in reference to FIG. 1, the aerial drones can relay data via another drone. In other embodiments, the aerial drones can store the location data, altitude data, ambient condition data, and communication signal strength data generated in steps 201 through 205 for later transmission once the aerial drones re-enter an area where there is sufficient wireless signal coverage. In exemplary embodiments, the computing system can also receive wireless communication signal type data from the aerial drones that can indicate whether a particular wireless communication signal type, such as a cellular signal or WiFi, is associated with a particular low signal strength zone. This information can be used to determine which particular type of wireless signal will provide the best signal strength coverage for that zone, in some embodiments.

In exemplary embodiments, the computing system can simultaneously determine the best signal type, drone capability, and the optimal drone path. The computing system can also determine an optimal antenna configuration (orientation, channel, frequency, modulation, etc.), in some embodiments. Changing the navigation route of a drone can change the communication signal type, in some embodiments, so iterative processing may be used in order to determine the optimal signal type after a drone path has been changed, or vice versa.

In step 209, the computing system stores the location data, altitude data, ambient condition data, and communication signal strength data at a database. In some embodiments, the computing system can update existing values within the database to reflect new data received from the aerial drones in order to maintain a dynamic and current database.

In step 211, the computing system generates a dynamic 3D communication map using a 3D map generation module that includes one or more computer-executable processes. The dynamic 3D communication map indicates the signal strength for each of the one or more wireless communication signal types as a function of the location data, altitude data, and ambient condition data received from the aerial drones. In some embodiments, the dynamic 3D communication map can indicate changes in signal strength that occur as a result of weather patterns, seasonal changes, temporary signal outages, or other real-time changes in signal strength that are detected by the sensors of the aerial drones. In exemplary embodiments, the 3D communication map can be dynamic in that the computing system can continuously receive real-time data from the aerial drones and dynamically update the 3D communication map in response to the newly received data.

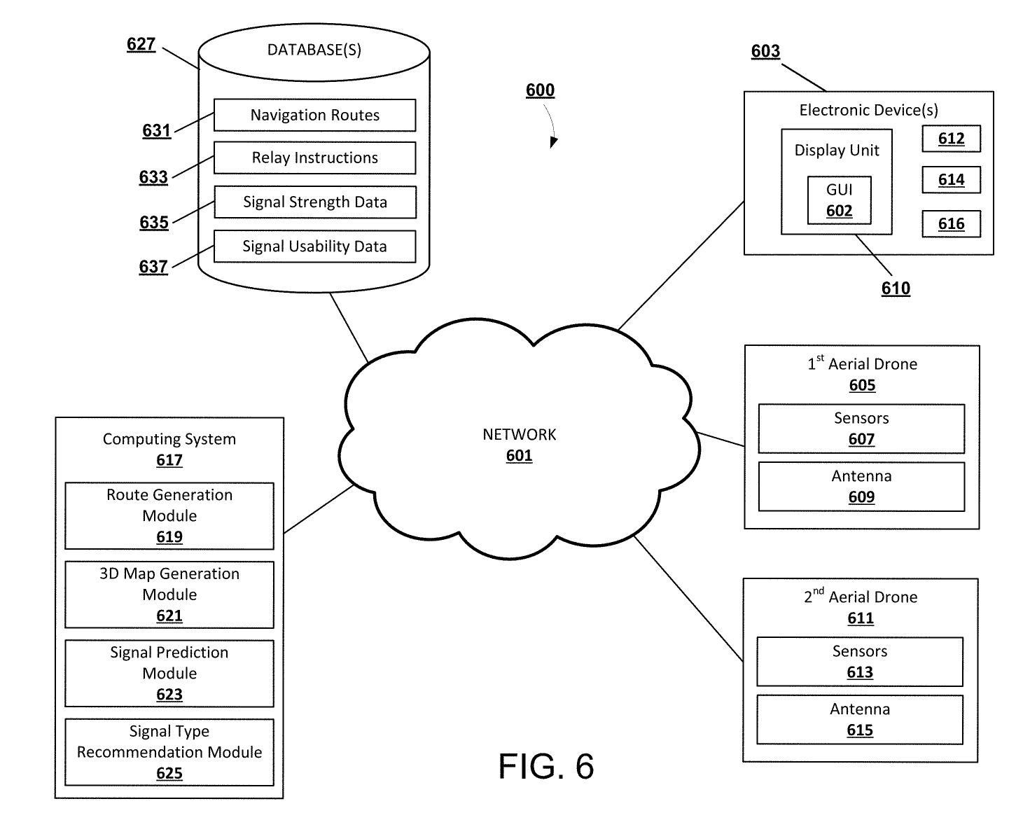

In some embodiments, the 3D communication maps disclosed herein can be displayed using, for example, an electronic device 603 as described in more detail below in reference to FIG. 6, a virtual reality headset, a projector, a display screen, or any other suitable display device.

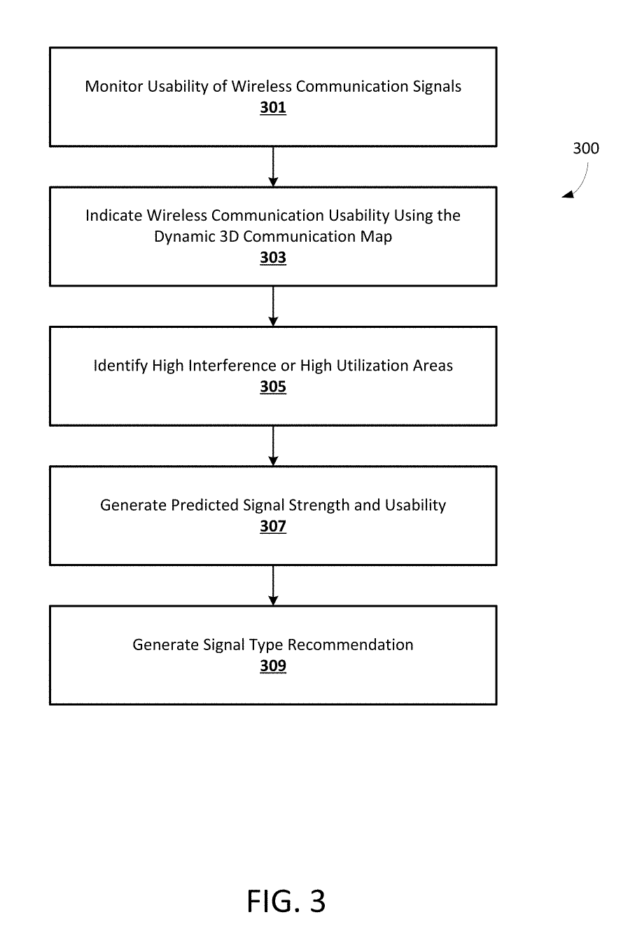

In one embodiment, the data from the dynamic 3D communication map can be combined with usability data to generate a dynamic 3D signal usability map. FIG. 3 is a flowchart illustrating an exemplary method 300 for generating a dynamic 3D signal usability map, according to an exemplary embodiment. It will be appreciated that the method is programmatically performed, at least in part, by one or more computer-executable processes executing on, or in communication with one or more servers or computing devices such as described further below. In step 301, the usability of the one or more wireless communication signal types is monitored using the communication signal sensor, and wireless communication usability data is generated. In some embodiments, the communication signal sensor can be a sensor configured to measure signal quality, signal bandwidth, signal noise, etc. In exemplary embodiments, wireless communication usability can be distinguished from wireless communication signal strength. For example, a wireless signal with relatively high signal strength may have low usability due to low bandwidth or increased user traffic. Therefore, it may be beneficial to know the usability of a wireless communication signal, in addition to the strength of that signal, in order to know whether one of the aerial drones will be able to send and receive communications. Similar to how the aerial drones discussed above in reference to FIG. 2 detect and communicate the signal strength of wireless communication signals, the aerial drones can also detect and transmit the usability of those wireless communication signals. In some embodiments, the aerial drones can monitor Urchin Tracking Module (UTM) parameters, which can track wireless communication traffic, associated with vehicles and other aerial drones within their vicinity. The aerial drones can also, in some embodiments, use optical images to identify vehicles or other aerial drones in particular areas and determine whether signal congestion is likely to occur.

In step 303, the data from the dynamic 3D communication map may be leveraged to indicate the wireless communication usability of the one or more wireless communication signal types based on the wireless communication usability data. Thus, a dynamic 3D wireless communication usability map can be generated, according to embodiments of the present disclosure. In some embodiments, both the wireless communication signal strength and the wireless communication usability can be visually depicted using a single dynamic 3D map. A user may be able to, in some embodiments, switch between a visual depiction of the wireless communication signal strength, as described above in reference to FIG. 2, and the wireless communication usability. In some embodiments, this 3D communication usability map can be dynamic, in that it can be updated in real-time based on wireless communication usability data that is continuously received from the aerial drones.

In step 305, the 3D map generation module determines a high interference area or a high utilization area within the dynamic 3D communication usability map. As discussed above, the usability of a wireless communication signal affected by a high signal utilization, increased signal interference, or other factors. Using the dynamic 3D communication usability map, various high interference or high utilization areas can be determined within the area covered by the 3D map. Knowing the communication signal usability of different areas can be helpful for navigating and setting routes for vehicles or aerial drones so that they do not lose communication capabilities.

In step 307, a predicted signal strength is generated using a signal prediction module that includes one or more computer-executable processes. In exemplary embodiments, the predicted signal strength uses expected ambient conditions at a particular location, altitude, and time in order to programmatically compute a predicted signal strength at the particular location, altitude, and time. For example, the 3D communication map can determine that signal strength for a particular wireless signal type decreases depending on particular ambient conditions, such as snow or thunderstorms. In such an example, the signal prediction module can predict that a similar decrease in signal strength may occur during a thunderstorm that is expected to pass through the area covered by the 3D communication map. Similarly, in some embodiments, the signal prediction module can generate a predicted signal usability value based on expected ambient conditions at a particular location, altitude, and time. For example, the 3D communication map can determine that the usability of a particular wireless signal typically decreases under predetermined ambient conditions such as known traffic patterns, sporting events, etc. In such an example, the signal prediction module can predict that a particular decrease in signal usability may occur during a sporting event that is scheduled within the area covered by the 3D communication map.

In exemplary embodiments, a navigational path through various coverage zones or areas can be adjusted to best fit the needs or technology capabilities of each particular drone. In some embodiments, the drone can re-configure to select an alternate signal type, and either the aerial drone or the computing system can select the alternate signal type. In some embodiments, a second aerial drone can be aware of which technology is most usable for its particular navigation route and which signal type to use to extend coverage to the first aerial drone. For example, a second drone may detect that its backhaul connection is best provided by omni-directional cellular and that a directional Wi-Fi signal may be best to communicate with the first aerial drone. In such an embodiment, the second aerial drone can orient or configure a Wi-Fi directional antenna to point toward the first aerial drone in order to maintain at least a one-way communication link between the two drones. In some cases, selecting a particular signal type or signal technology can be the only way to achieve even a one-way communication link.

In step 309, a wireless communication signal type recommendation is generated using a signal type recommendation module that includes one or more computer-executable processes. In exemplary embodiments, the wireless communication signal type recommendation can indicate which wireless communication signal type may have a strong signal at a particular time and place. The wireless communication signal type recommendation module may transmit the recommendation to one or more autonomous drones that have been configured to accept the recommendation while they are in transit. In other embodiments, the wireless communication signal type recommendation can indicate which wireless communication signal type may have strong usability at a particular time and place. This recommendation can be used, in some embodiments, in order to determine which wireless signal type may be the best for relaying communications, as described above in reference to FIG. 1. For example, the signal type recommendation may prompt the aerial drone to utilize a cellular connection while passing through an area where the WiFi signal is expected to be weak. In some embodiments, the signal type recommendation can also be configured to prompt the aerial drone to utilize a particular signal type in order to avoid a low signal usability zone associated with one or more particular signal types.

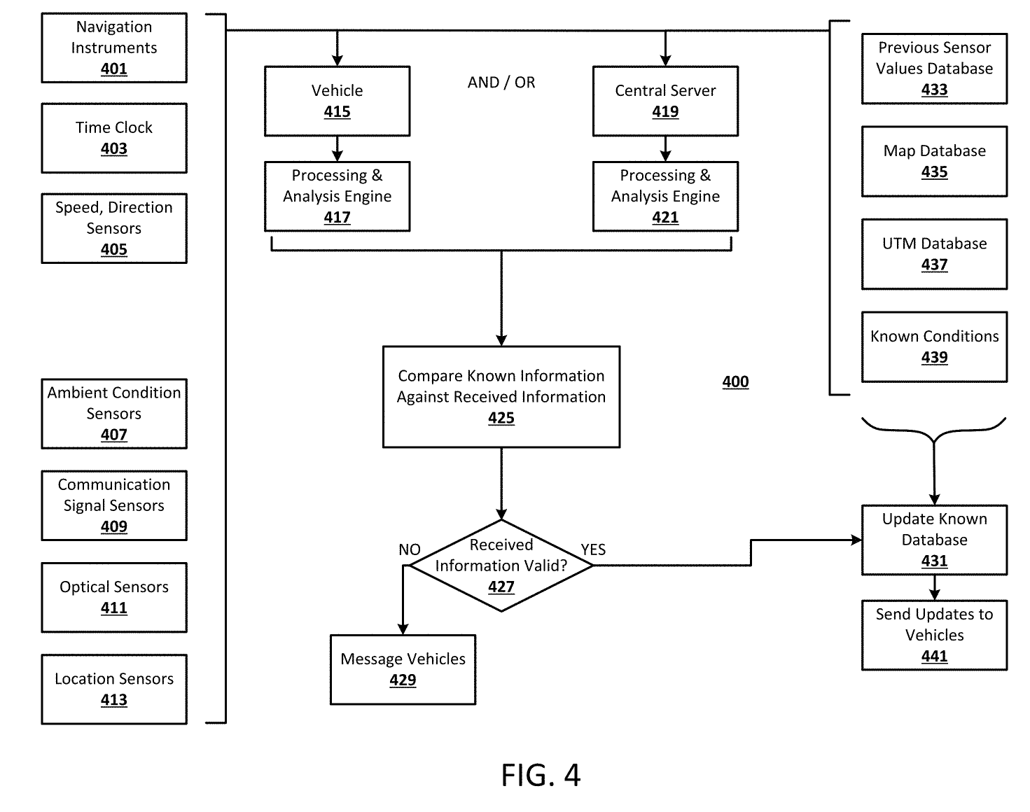

FIG. 4 is a flowchart illustrating an exemplary method 400 for processing data used in dynamically generating a 3D communication map, according to an exemplary embodiment. It will be appreciated that the method is programmatically performed, at least in part, by one or more computer-executable processes executing on, or in communication with one or more servers or other computing devices such as described further below. In this example embodiment, real-time vehicle analysis of a vehicle, such as an aerial drone, can be performed using navigation instruments 401, the time clock 403 associated with the aerial drone, and speed and direction sensors 405. In addition, various sensors associated with the aerial drone can collect data while the aerial drone is completing a route. These sensors can include, for example, ambient condition sensors 407, communication signal sensors 409 configured to monitor the communication signal strength and communication signal usability, optical sensors 411, and location sensors 413. Optical sensors can include, for example, cameras, laser sensors, IR sensors, etc. In some embodiments, optical sensors can be used to identify weather patterns, vehicle density, or other structural features and obstacles.

The information gathered from the sensors 407, 409, 411, and 413, as well as the navigation instruments 401, time clock 403, and speed and direction sensors 405 can be compared against known input values in order to generate and update information used to generate the 3D communication map. Known values can be collected, for example, from a database 433 of previous sensor values, a map database 435 including information collected from various types of maps or mapping software, a Unified Threat Management (UTM) database 437, and known conditions database 439 such as known or weather and time data. These known values from databases 433-439 can be compared against the dynamically received values from the sensors 405-413, the navigation instruments 401, and the time clock 403. In some embodiments, the processing of this comparison can be performed either by a processing and analysis engine 417 associated with the vehicle 415 or by a processing and analysis engine 421 associated with the central server 419. In both cases, the processing and analysis engine 417 and 421 may include one or more computer-executable processes. In alternative embodiments, the processing can be distributed between both the vehicle 415 and the central server 419. In some embodiments, if the vehicle 415 is overloaded and does not have available processing power, the processing and analysis engine 421 associated with the central server 419 can perform the comparison described above.

At 425, the known information from databases 433-439 is compared against the dynamically received information received from elements 401-413. In some embodiments, the received information can be determined to be invalid if it is too far from a known value, and therefore considered an outlier. If the received information is determined in 427 to be invalid, the appropriate vehicle from which the invalid information was received may be messaged at 429 in order to notify the vehicle that it collected an invalid data point. If the information is valid, the known database is updated 431, and the updates are sent to the vehicles 441.

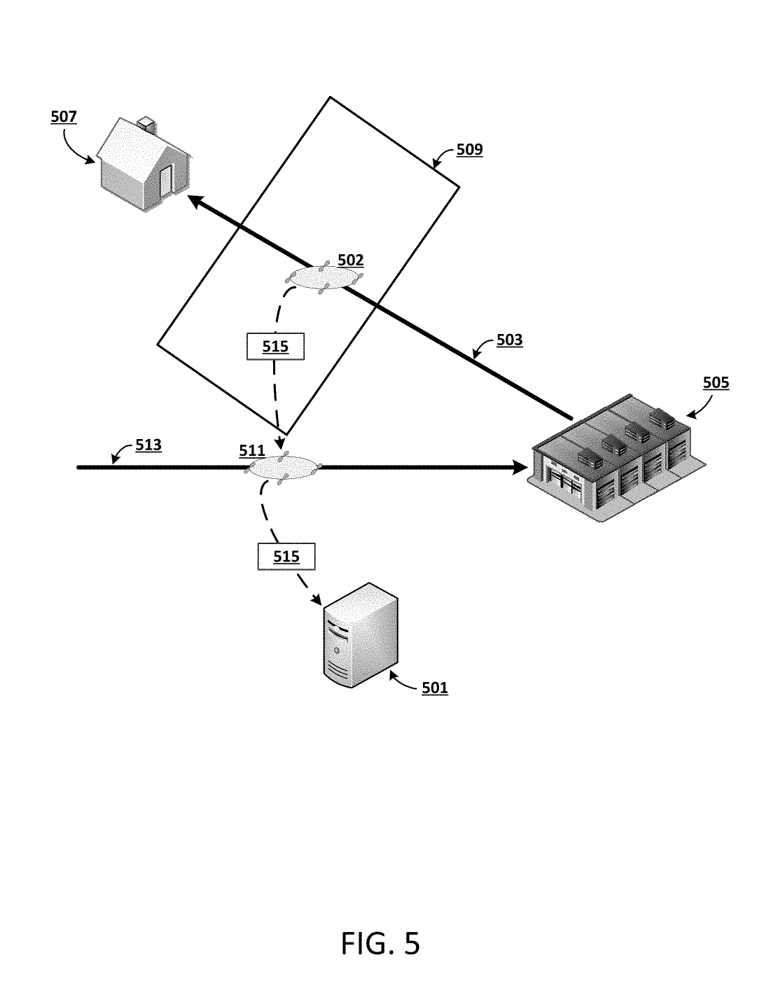

FIG. 5 is a chart of example navigation routes for relaying messages in limited communication coverage zones, according to an exemplary embodiment. In this particular embodiment, a first aerial drone 502 is configured to travel along a first navigation route 503 between an origin location 505 and a destination location 507. The first aerial drone 502 is configured to be in communication with the remote computing system 501, but must pass through a limited coverage zone 509 while completing the first navigation route 503. The limited coverage zone 509 can include, for example, an area where the first aerial drone 502 is not able to transmit communications, or where the ability to send and/or receive communications is unreliable.

In this example embodiment, a second aerial drone 511 is configured to travel along a second navigation route 513, which guides the second aerial drone 511 near the limited coverage zone 509 and within communication range of the first aerial drone 511 when it is passing through the limited coverage zone 509. By passing near the limited coverage zone 509, the second aerial drone 511 is able to communicate with the first aerial drone 502 while it is passing through the limited coverage zone 509 in order to relay a message 515 or information packet between the first aerial drone 502 and the remote computing system 501.

In some embodiments, the first aerial drone 502 and/or the second aerial drone 511 can include a configurable antenna that is capable of being reconfigured, altered, or adjusted in order to improve transmission range. Such an antenna can reduce the size of a limited coverage zone 509 or improve the ability of the first aerial drone 502 and the second aerial drone 511 to relay information to the remote computing system 501.

In one embodiment, the navigation routes traveled by the first aerial drone 502 and the second aerial drone 511 are determined before transit based on known limited coverage zones. In another embodiment, one or both of the navigation routes for the first aerial drone 502 and the second aerial drone 511 may be dynamically determined by a remote computer based on updates to the dynamic 3D communication map or dynamic 3D usability map that occur while the aerial drones are in transit. For example, the dynamic 3D Communication Map or the dynamic 3D usability map may be updated to reflect a drop in signal strength or usability as a result of a just discovered or transient condition such as a storm or discovered network congestion. In such a case, zones that were previously thought to be of adequate signal reliability may become limited coverage zones and the system may dispatch the second aerial zone to a nearby location to act as a relay for the first aerial zone.

FIG. 6 illustrates a network diagram depicting a system 600 suitable for a distributed implementation of an exemplary embodiment. The system 600 can include a network 601, an electronic device 603, a first aerial drone 605, a second aerial drone 611, a computing system 617, and a database 627. In exemplary embodiments, the first aerial drone 605 includes sensors 607 for collecting data used to generate a dynamic 3D communication map and an antenna 609 for communicating with the second aerial drone 611 and the computing system 617. The first aerial drone 605 and the second aerial drone 611 can be in communication with the computing system 617 and with each other over the network 601. As will be appreciated, various distributed or centralized configurations may be implemented without departing from the scope of the present invention. In some embodiments, the computing system 617 can store and execute a route generation module 619, a 3D map generation module 621, a signal prediction module 623, and a signal type recommendation module 625, which can implement one or more of the processes described herein, or portions thereof. It will be appreciated that the module functionality may be implemented as a greater number of modules than illustrated and that the same server, computing system, or autonomous drone could also host multiple modules. The database 627 can store the navigation routes 631, relay instructions 633, signal strength data 635, and signal usability data 637, as discussed herein. In some embodiments, the 3D map generation module 621 can generate a dynamic 3D communication signal strength map and/or a dynamic 3D communication signal usability map and communicate with the electronic device 603 in order to render the dynamic 3D map using a display unit 610.

In exemplary embodiments, the electronic device 603 may include a display unit 610, which can display a GUI 602 to a user of the electronic device 603. The electronic device can also include a memory 612, processor 614, and a wireless interface 616. In some embodiments, the electronic device 603 may include, but is not limited to, computers, general purpose computers, Internet appliances, hand-held devices, wireless devices, portable devices, wearable computers, cellular or mobile phones, portable digital assistants (PDAs), smart phones, tablets, ultrabooks, netbooks, laptops, multi-processor systems, microprocessor-based or programmable consumer electronics, game consoles, network PCs, mini-computers, smartphones, and the like.

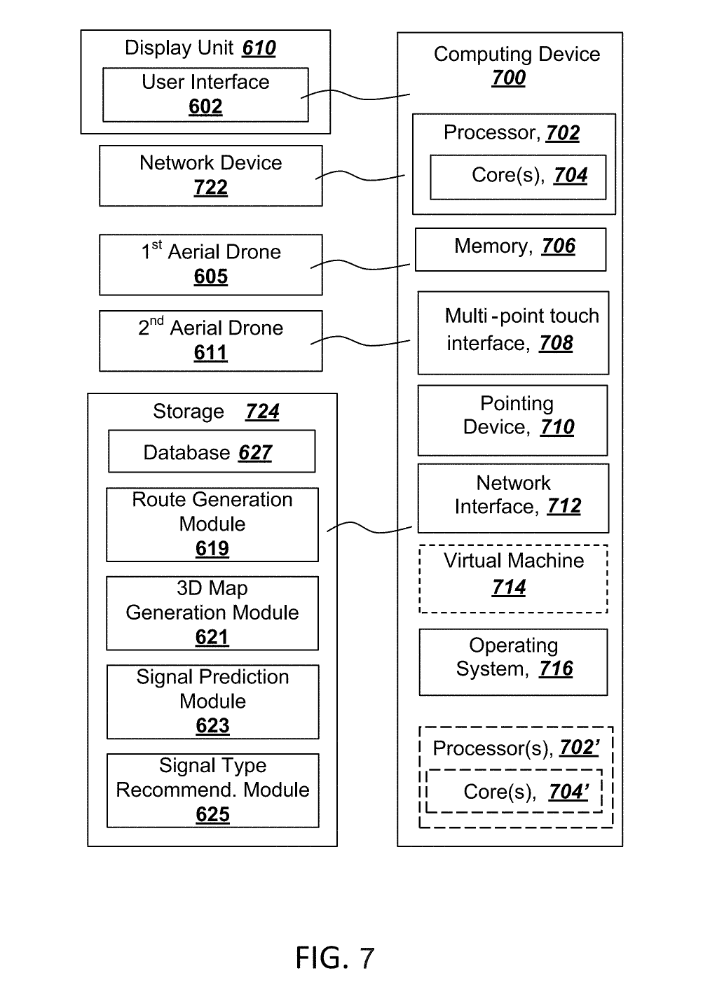

The electronic device 603, first aerial drone 605, second aerial drone 611, and the computing system 617 may connect to the network 601 via a wireless connection, and the electronic device 603 may include one or more applications such as, but not limited to, a web browser, a sales transaction application, a geo-location application, and the like. The computing system 617 may include some or all components described in relation to computing device 700 shown in FIG. 7.

The communication network 601 may include, but is not limited to, the Internet, an intranet, a LAN (Local Area Network), a WAN (Wide Area Network), a MAN (Metropolitan Area Network), a wireless network, an optical network, and the like. In one embodiment, the electronic device 603, first aerial drone 605, second aerial drone 611, computing system 617, and database 627 can transmit instructions to each other over the communication network 601. In exemplary embodiments, the navigation routes 631, relay instructions 633, signal strength data 635, and signal usability data 637 can be stored at the database 627 and received at the electronic device 603, first aerial drone 605, second aerial drone 611, or the computing system 617 in response to a service performed by a database retrieval application.

FIG. 7 is a block diagram of an exemplary computing device 700 that can be used in the performance of the methods described herein. The computing device 700 includes one or more non-transitory computer-readable media for storing one or more computer-executable instructions (such as but not limited to software or firmware) for implementing any example method according to the principles described herein. The non-transitory computer-readable media can include, but are not limited to, one or more types of hardware memory, non-transitory tangible media (for example, one or more magnetic storage disks, one or more optical disks, one or more USB flashdrives), and the like.

For example, memory 706 included in the computing device 700 can store computer-readable and computer-executable instructions or software for implementing exemplary embodiments and programmed to perform processes described above in reference to FIGS. 1-4. The computing device 700 also includes processor 702 and associated core 704, and optionally, one or more additional processor(s) 702′ and associated core(s) 704′ (for example, in the case of computer systems having multiple processors/cores), for executing computer-readable and computer-executable instructions or software stored in the memory 706 and other programs for controlling system hardware. Processor 702 and processor(s) 702′ can each be a single core processor or multiple core (704 and 704′) processor.

Virtualization can be employed in the computing device 700 so that infrastructure and resources in the computing device can be shared dynamically. A virtual machine 714 can be provided to handle a process running on multiple processors so that the process appears to be using only one computing resource rather than multiple computing resources. Multiple virtual machines can also be used with one processor.

Memory 706 can be non-transitory computer-readable media including a computer system memory or random access memory, such as DRAM, SRAM, EDO RAM, and the like. Memory 706 can include other types of memory as well, or combinations thereof.

A user can interact with the computing device 700 through a display unit 610, such as a touch screen display or computer monitor, which can display one or more user interfaces 602 that can be provided in accordance with exemplary embodiments. In some embodiments, the display unit 610 can also display the dynamic 3D communication map disclosed herein. The computing device 700 can also include other I/O devices for receiving input from a user, for example, a keyboard or any suitable multi-point touch interface 708, a pointing device 710 (e.g., a pen, stylus, mouse, or trackpad). The multi-point touch interface 708 and the pointing device 710 can be coupled to the display unit 610. The computing device 700 can include other suitable conventional I/O peripherals.

The computing device 700 can also include one or more storage devices 724, such as a hard-drive, CD-ROM, or other non-transitory computer readable media, for storing data and computer-readable instructions and/or software, such as a route generation module 619, 3D map generation module 621, signal prediction module 623, and signal type recommendation module 625 that can implement exemplary embodiments of the methods and systems as taught herein, or portions thereof. Exemplary storage device 724 can also store one or more databases 627 for storing any suitable information required to implement exemplary embodiments. The database 627 can be updated by a user or automatically at any suitable time to add, delete, or update one or more items in the databases. Exemplary storage device 724 can store a database 627 for storing the navigation routes 631, relay instructions 633, signal strength data 635, signal usability data 637, and any other data/information used to implement exemplary embodiments of the systems and methods described herein.

The computing device 700 can also be in communication with the first aerial drone 605 and the second aerial drone 611. In exemplary embodiments, the computing device 700 can include a network interface 712 configured to interface via one or more network devices 722 with one or more networks, for example, Local Area Network (LAN), Wide Area Network (WAN) or the Internet through a variety of connections including, but not limited to, standard telephone lines, LAN or WAN links (for example, 802.11, T1, T3, 56kb, X.25), broadband connections (for example, ISDN, Frame Relay, ATM), wireless connections, controller area network (CAN), or some combination of any or all of the above. The network interface 712 can include a built-in network adapter, network interface card, PCMCIA network card, card bus network adapter, wireless network adapter, USB network adapter, modem or any other device suitable for interfacing the computing device 700 to any type of network capable of communication and performing the operations described herein. Moreover, the computing device 700 can be any computer system, such as a workstation, desktop computer, server, laptop, handheld computer, tablet computer (e.g., the iPad® tablet computer), mobile computing or communication device (e.g., the iPhone® communication device), or other form of computing or telecommunications device that is capable of communication and that has sufficient processor power and memory capacity to perform the operations described herein.

The computing device 700 can run operating system 716, such as versions of the Microsoft® Windows® operating systems, different releases of the Unix and Linux operating systems, versions of the MacOS® for Macintosh computers, embedded operating systems, real-time operating systems, open source operating systems, proprietary operating systems, operating systems for mobile computing devices, or other operating systems capable of running on the computing device and performing the operations described herein. In exemplary embodiments, the operating system 716 can be run in native mode or emulated mode. In an exemplary embodiment, the operating system 716 can be run on one or more cloud machine instances.

In describing example embodiments, specific terminology is used for the sake of clarity. For purposes of description, each specific term is intended to at least include all technical and functional equivalents that operate in a similar manner to accomplish a similar purpose. Additionally, in some instances where a particular example embodiment includes system elements, device components or method steps, those elements, components or steps can be replaced with a single element, component or step. Likewise, a single element, component or step can be replaced with multiple elements, components or steps that serve the same purpose. Moreover, while example embodiments have been shown and described with references to particular embodiments thereof, those of ordinary skill in the art will understand that various substitutions and alterations in form and detail can be made therein without departing from the scope of the disclosure. Further still, other aspects, functions and advantages are also within the scope of the disclosure.

Example flowcharts are provided herein for illustrative purposes and are non-limiting examples of methods. One of ordinary skill in the art will recognize that example methods can include more or fewer steps than those illustrated in the example flowcharts, and that the steps in the example flowcharts can be performed in a different order than the order shown in the illustrative flowcharts.

What is claimed is:

1. A system for generating aerial drone routes, the system comprising:
a first aerial drone configured to travel from an origin location to a destination location and further configured to periodically transmit information to a remote computing device;
a second aerial drone configured to communicate with the first aerial drone; and
the remote computing device equipped with a processor, the remote computing device configured to communicate with the first aerial drone and the second aerial drone and execute a route generation module to:
receive wireless communication signal strength data from a 3D communication map, the wireless communication signal strength data indicating a limited coverage zone between the origin location and the destination location;
generate a first navigation route configured to guide the first aerial drone from the origin location to the destination location by passing through the limited coverage zone;
generate a second navigation route configured to guide the second aerial drone near the limited coverage zone and within communication range of the first aerial drone when the first aerial drone is passing through the limited coverage zone;
generate relay instructions configured to prompt the first aerial drone to relay the information to the remote computing device via the second aerial drone;
transmit the first navigation route and the relay instructions to the first aerial drone; and
transmit the second navigation route to the second aerial drone.

2. The system of claim 1, wherein the first aerial drone or the second aerial drone are configured to alter a configuration of an antenna to improve a transmission range.

3. The system of claim 1, wherein the second aerial drone is further configured to:
record time delay information caused by relaying the information via the second aerial drone; and
transmit the time delay information to the remote computing device.

4. The system of claim 1, wherein the second aerial drone further comprises:
a communication processor configured to relay the information to the remote computing device, the communication processor being separate and independent from a primary processor of the second aerial drone.

5. The system of claim 1, wherein the second aerial drone is further configured to:
resume a previous navigation route after relaying the information to the remote computing device.

6. The system of claim 1, wherein the remote computing device is further configured to:
select the second aerial drone from a plurality of aerial drones based, at least in part, on drone location, ambient conditions, security of the information, time delivery requirements, or battery life.

7. The system of claim 1, wherein the first navigation route is further configured to guide the first aerial drone temporarily through a zone with no connectivity in order to reach the limited coverage zone.

8. A method for generating aerial drone routes, the method comprising:
receiving wireless communication signal strength data at a remote computing device from a 3D communication map, the wireless communication signal strength data indicating a limited coverage zone between an origin location and a destination location;
generating a first navigation route configured to guide a first aerial drone from the origin location to the destination location by passing through the limited coverage zone, wherein the first aerial drone is configured to periodically transmit information to the remote computing device;
generating a second navigation route configured to guide a second aerial drone near the limited coverage zone and within communication range of the first aerial drone when the first aerial drone is passing through the limited coverage zone, wherein the second aerial drone is configured to communicate with the first aerial drone;
generating relay instructions configured to prompt the first aerial drone to relay the information to the remote computing device via the second aerial drone;
transmitting the first navigation route and the relay instructions to the first aerial drone; and
transmitting the second navigation route to the second aerial drone.

9. The method of claim 8, further comprising:
altering a configuration of an antenna associated with the first aerial drone or the second aerial drone to improve a transmission range.

10. The method of claim 8, further comprising:
recording time delay information caused by relaying the information via the second aerial drone; and
transmitting the time delay information to the remote computing device.

11. The method of claim 8, further comprising:
wherein the relay instructions are configured to prompt the second aerial drone to relay the information to the remote computing device using a communication processor that is separate and independent from a primary processor of the second aerial drone.

12. The method of claim 8, further comprising:
resuming a previous navigation route of the second aerial drone after relaying the information to the remote computing device.

13. The method of claim 8, further comprising:
selecting the second aerial drone from a plurality of aerial drones based, at least in part, on drone location, ambient conditions, security of the information, time delivery requirements, or battery life.

14. The method of claim 8, wherein the first navigation route is further configured to guide the first aerial drone temporarily through a zone with no connectivity in order to reach the limited coverage zone.

15. A non-transitory machine readable medium storing instructions executable by a processing device, wherein execution of the instructions causes the processing device to implement a method for generating aerial drone routes, the method comprising:
receiving wireless communication signal strength data at a remote computing device from a 3D communication map, the wireless communication signal strength data indicating a limited coverage zone between an origin location and a destination location;
generating a first navigation route configured to guide a first aerial drone from the origin location to the destination location by passing through the limited coverage zone, wherein the first aerial drone is configured to periodically transmit information to the remote computing device;
generating a second navigation route configured to guide a second aerial drone near the limited coverage zone and within communication range of the first aerial drone when the first aerial drone is passing through the limited coverage zone, wherein the second aerial drone is configured to communicate with the first aerial drone;
generating relay instructions configured to prompt the first aerial drone to relay the information to the remote computing device via the second aerial drone;
transmitting the first navigation route and the relay instructions to the first aerial drone; and
transmitting the second navigation route to the second aerial drone.

16. The non-transitory machine readable medium of claim 15, wherein execution of the instructions further causes the processing device to:
alter a configuration of an antenna associated with the first aerial drone or the second aerial drone to improve information transmission range.

17. The non-transitory machine readable medium of claim 15, wherein execution of the instructions further causes the processing device to:
record time delay information caused by relaying the information via the second aerial drone; and
transmit the time delay information to the remote computing device.

18. The non-transitory machine readable medium of claim 17, wherein the relay instructions are configured to prompt the second aerial drone to relay the information to the remote computing device using a communication processor that is separate and independent from a primary processor of the second aerial drone.

19. The non-transitory machine readable medium of claim 17, wherein execution of the instructions further causes the processing device to:
prompt the second aerial drone to resume a previous navigation route after relaying the information to the remote computing device.

20. The non-transitory machine readable medium of claim 15, wherein execution of the instructions further causes the processing device to:
select the second aerial drone from a plurality of aerial drones based, at least in part, on drone location, ambient conditions, security of the information, time delivery requirements, or battery life.
